(19) United States
(12) Patent Application Publication
(10) Pub. No.: US 2007/0220567 A1
(43) Pub. Date: Sep. 20, 2007

(54) Method and Related Device for Scheduling Sequence of Broadcasting Data Items in an On-demand Broadcast System

(76) Inventor: CHIH-LIN HU, Tai-Nan City (TW)

Correspondence Address: NORTH AMERICA INTELLECTUAL PROPERTY CORPORATION, P.O. BOX 506, MERRIFIELD, VA, 22116, US

(21) Appl. No.: 11/673,600

(22) Filed: Feb. 12, 2007

(30) Foreign Application Priority Data
Feb. 24, 2006 (TW) 095106408

(51) Int. Cl. H04N 7/173

(52) U.S. Cl. 725/97; 725/86; 725/101

(57) ABSTRACT

A method is utilized for scheduling sequence of broadcasting data items in an on-demand broadcast system. The system includes a plurality of data items. The method includes receiving a plurality of requests, calculating a request number of the plurality of requests, calculating a waiting time and an accumulated waiting time relative to a current time of each request, calculating a weighted value according to the request number and the accumulative waiting time, and scheduling the sequence of broadcasting the data item of the plurality of requests according to the weighted value.

### BACKGROUND OF THE INVENTION

1. Field of the Invention

The present invention relates to a method for scheduling a sequence of broadcasting data items in an on-demand broadcast system, and more particularly, to a method for scheduling a sequence of broadcasting data items according to weighted values of the plurality of data items.

2. Description of the Prior Art

Current scheduling algorithms are mostly used in peer-to-peer broadcast systems. However, a time limit is commonly not taken as a factor in current on-demand broadcast scheduling algorithms. The earliest deadline first (EDF) algorithm is one of the most typical scheduling algorithms. While scheduling the sequence of broadcasting data items in the earliest deadline first algorithm, the data item having the shortest life cycle is the first to be broadcasted so that the urgent request of broadcasting the data item is met. Implementing the earliest deadline first algorithm in systems having light loads leads to a good performance. However, when the effective deadline of a data item is shorter than the life cycle of the data item, the earliest deadline first algorithm cannot fulfill requests well, and huge amounts of system resources are thus wasted. Finally, more and more requests cannot be fulfilled by the earliest deadline first algorithm, which leads to the so-called domino effect. The most requests first (MRF) algorithm is another typical scheduling algorithm. While scheduling the sequence of broadcasting data items by the most requests first algorithm, the data item having the most requests is the first to be broadcasted for achieving better productivity.

Considering both the urgency and the productivity, an algorithm called the sin-α algorithm is published for enhancing the efficiency of scheduling the sequence of broadcasting data items. The sin-α algorithm calculates a sin α value of each request as follows:

sin α=(the first deadline minus the current time)/(request number)^{α};

The first deadline denotes a deadline of a most urgent request. The request number denotes the number of requests of broadcasting a data item. α denotes an adjustable value, and the value of the adjustable value α is not less than zero. The adjustable value α represents a ratio of the urgency to the productivity. In the sin-α algorithm, a sin α value of each data item to be broadcasted is calculated first, and the data item having the smallest sin α value is the first to be broadcasted.

In the sin-α algorithm, two factors are taken into consideration. The first factor is: when the request numbers of two data items to be broadcasted are the same, the data item having a more urgent deadline is first to be broadcasted. The second factor is: when the deadlines of two data items to be broadcasted are the same, the data item having a larger request number is the first to be broadcasted. Through the sin-α algorithm, less errors and higher efficiency are achieved.

Under some circumstances, it is inappropriate to use the sin-α algorithm. Please refer to FIG. 1, which is a first diagram of scheduling a sequence of broadcasting data items with the sin-α algorithm. In FIG. 1, there are two data items to be broadcasted, and the data items are a first data item DI₁ and a second data item DI₂. The first data item DI₁ has four requests, which are RA₁, RA₂, RA₃, and RA₄ in order. The second data item DI₂ has four requests, which are RB₁, RB₂, RB₃, and RB₄ in order. A second deadline et₂ of the second data item DI₂ is earlier than a first deadline et₁ of the first data item DI₁. According to the abovementioned factors of the sin-α algorithm, the second data item DI₂ is the first to be broadcasted, however, a mean access time when the second data item DI₂ is the first to be broadcasted would be longer than a mean access time when the first data item DI₁ is the first to be broadcasted. Assume the second data item DI₂ is broadcasted at the current time t shown in FIG. 1, and assume the first data item DI₁ is broadcasted at the time (t+1) or (t+2), therefore, when the second data item DI₂ is the first to be broadcasted, the mean access time is 5; and when the first data item DI₁ is the first to be broadcasted, the mean access time is 4.75.

Please refer to FIG. 2, which is a second diagram of scheduling a sequence of broadcasting data items with the sin-α algorithm. As shown in FIG. 2, there are two data items to be broadcasted, and the two data items are a first data item DI₁ and a second data item DI₂. The first data item DI₁ has three requests, which are RA₁, RA₂, and RA₃ in order. The second data item DI₂ has four requests, which are RB₁, RB₂, RB₃, and RB₄ in order. A first end time et₁ of the first data item DI₁ occurs at the same time as a second end time et₂ of the second data item DI₂. According to the abovementioned second factor of the sin-α algorithm, the second data item DI₂ is the first to be broadcasted. Assume the second data item DI₂ is broadcasted at a current time t shown in FIG. 2, and assume the first data item DI₁ is broadcasted at the time (t+1) or (t+2), therefore, when the second data item DI₂ is the first to be broadcasted, the mean access time is 5; and when the first data item DI₁ is the first to be broadcasted, the mean access time is 4.6. The mean access time when the data item DI₂ is the first to be broadcasted is less than the mean access time when the data item DI₁ is the first to be broadcasted, and it is because the mean access time is increased by more requests. However, while meeting a great amount of requests, an unfair phenomenon appears according to the above-mentioned second factor of the sin-α algorithm.

Another unfair phenomenon appears when the request numbers of two data items to be broadcasted are the same, and so are the end times of both the data items. Under such condition, it cannot be determined which data item is the first to be broadcasted according to the sin-α algorithm.

Since only meeting the urgency of the requests is taken into consideration in the earliest deadline algorithm, and since only achieving higher productivity is taken into consideration in the most requests first algorithm, neither of the algorithms meets the requirements of users. The sin-α algorithm, which takes both meeting the urgency of the requests and achieving higher productivity into consideration, though, under certain conditions, still cannot perfectly fulfill the requirements of users. Moreover, the algorithms lead to lower system efficiency under some circumstances, especially when applying the algorithms in an on-demand broadcast system having a great amount of requests at its service terminals.

### SUMMARY OF THE INVENTION

The present invention provides a method for scheduling sequence of broadcasting data items in an on-demand broadcast system. The on-demand broadcast system comprising a plurality of data items. The method comprises receiving a plurality of requests, each of the plurality of requests requesting to broadcast a data item, calculating a request number of the plurality of requests wherein the request number represents the number of the plurality of requests, calculating a waiting time of each of the plurality of requests, each of the waiting times corresponding to a current time, summing each of the waiting times as an accumulated waiting time, calculating a weighted value according to the request number and the accumulated waiting time, and scheduling the order of broadcasting the plurality of data items according to the calculated weighted values of the plurality of data items.

The present invention provides a system for scheduling sequence of broadcasting data items. The system is utilized for communicating with a plurality of service terminals. The system comprises a database utilized for storing a plurality of data items, a service queue, a receiving unit utilized for receiving a plurality of requests from the plurality of service terminals, the plurality of requests corresponding to a data item in the database, a scheduler utilized for calculating a weighted value and scheduling the order of putting the data item into the service queue, the weighted value corresponding to a request number of the plurality of requests and to a sum of waiting times of the plurality of requests, the waiting times of the plurality of requests corresponding to a current time, and a transmission unit coupled to the service queue and utilized for downloading the data item to the plurality of service terminals.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 and FIG. 2 are diagrams of scheduling a sequence of broadcasting data items with the sin-α algorithm.

FIG. 3 is a diagram of performing the data item broadcast scheduling service of the present invention.

FIG. 4 is a flow chart of a procedure of the method of scheduling the sequence of broadcasting data items of the present invention.

FIG. 5 is a diagram of describing the formula of scheduling a sequence of broadcasting data items of the present invention.

FIG. 6 is a diagram illustrating the formula issued in FIG. 5 for scheduling a request of the present invention.

FIG. 7 is a diagram illustrating a plurality of formulae for scheduling a corresponding plurality of requests.

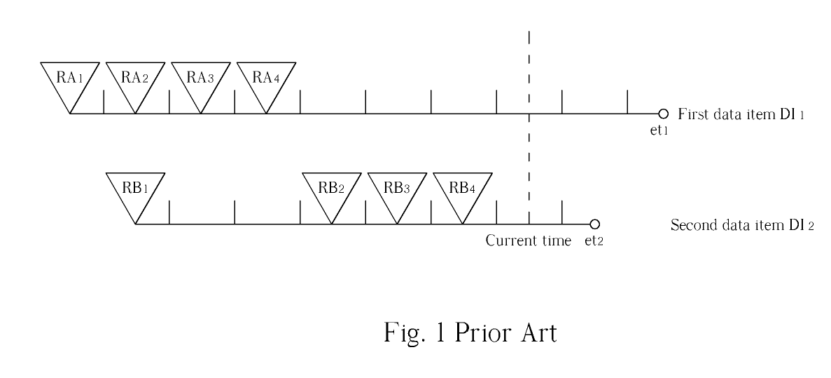

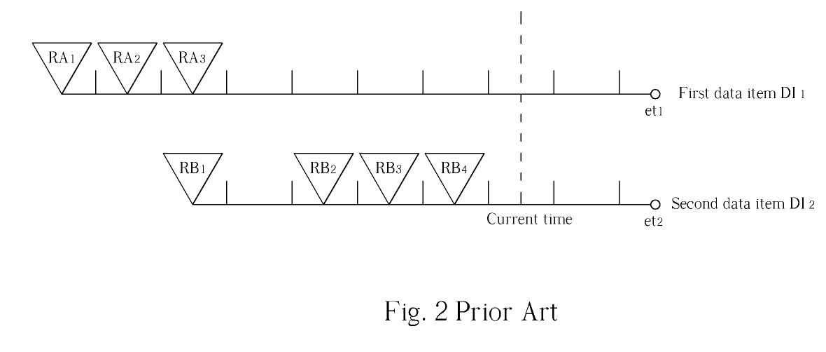

### DETAILED DESCRIPTION

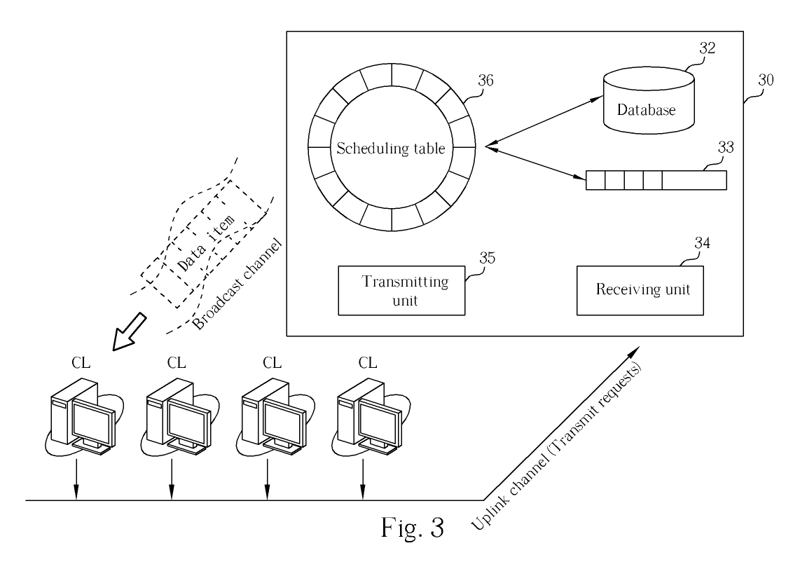

Please refer to FIG. 3, which is a diagram of performing the data item broadcast scheduling service of the present invention. As shown in FIG. 3, there are a data item broadcast scheduling service system 30 and a plurality of service terminals CL in a network. The data item broadcast scheduling system 30 is a server. The plurality of service terminals CL transmits a plurality of requests to the data item broadcast scheduling service system 30 through an uplink channel as shown in FIG. 3, and the plurality of requests corresponds to a single data item in the data item broadcast scheduling service system 30. The data item broadcast scheduling service system 30 comprises a database 32, a service queue 33, a scheduling table 36, a receiving unit 34, and a transmitting unit 35. The database 32 is utilized for storing a plurality of data items. The receiving unit 34 is utilized for receiving a plurality of requests transmitted from the plurality of service terminals CL. The scheduling table 36 is utilized for calculating a weighted value of a data item, and for scheduling the sequence (or the order) that the data item is put into the service queue 33. The weighted value of a data item relates to a request number, which is the number of the plurality of requests of the data item, and to an accumulated waiting time relating to a current time. The accumulated waiting time is further described later. The transmitting unit 35 is coupled to the service queue 33, and is utilized for downloading the data item to the plurality of service terminals CL through a broadcast channel shown in FIG. 3.

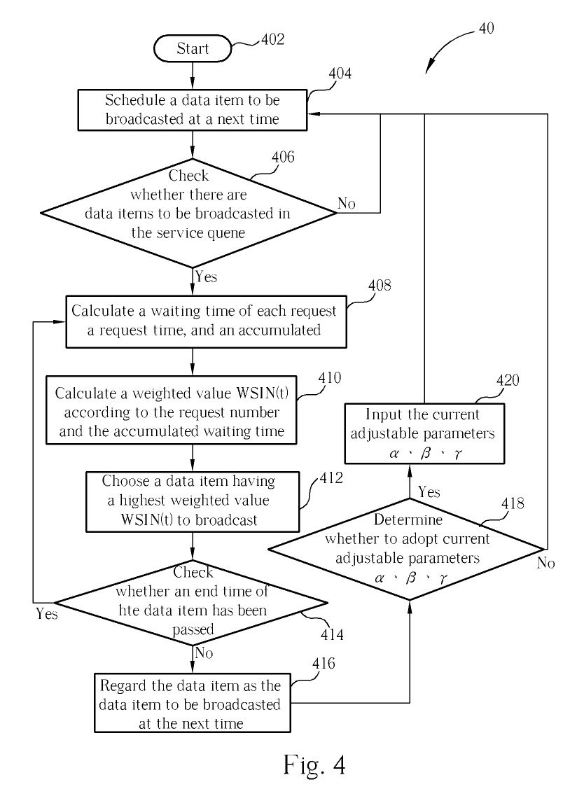

Please refer to FIG. 4, which is a flow chart of a procedure 40 of the method of scheduling the sequence of broadcasting data items of the present invention. The procedure 40 comprises the following steps:

Step 402: Start;

Step 404: Schedule a data item to be broadcasted at a next time;

Step 406: Check whether there are data items to be broadcasted in the service queue; when there are data items to be broadcasted in the service queue, go to step 408, otherwise, go to step 404;

Step 408: Calculate a waiting time of each request, and calculate a request number and an accumulated waiting time;

Step 410: Calculate a weighted value WSIN(t) according to the request number and the accumulated waiting time;

Step 412: Choose a data item having a highest weighted value WSIN(t) to broadcast;

Step 414: Check whether an end time of the data item has been passed; when the end time of the data item has been passed, go to step 408, otherwise, go to step 416;

Step 416: Regard the data item as the data item to be broadcasted at the next time;

Step 418: Determine whether to adopt current adjustable parameters α, β, and γ; when the current adjustable parameters α, β, and γ are to be adopted, go to step 420, otherwise, go to step 404; and

Step 420: Input the current adjustable parameters α, β, and γ.

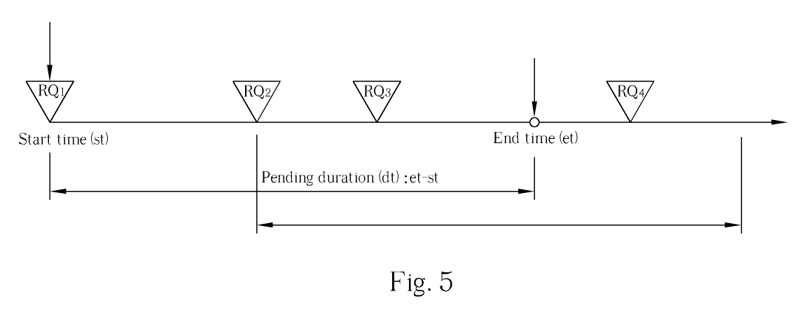

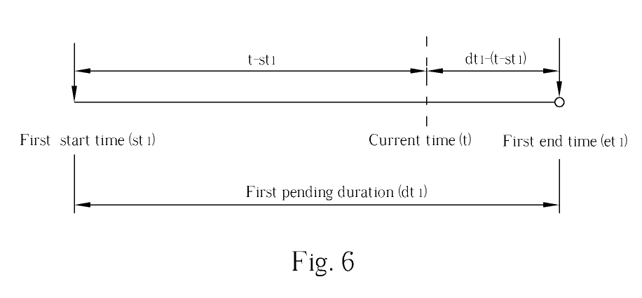

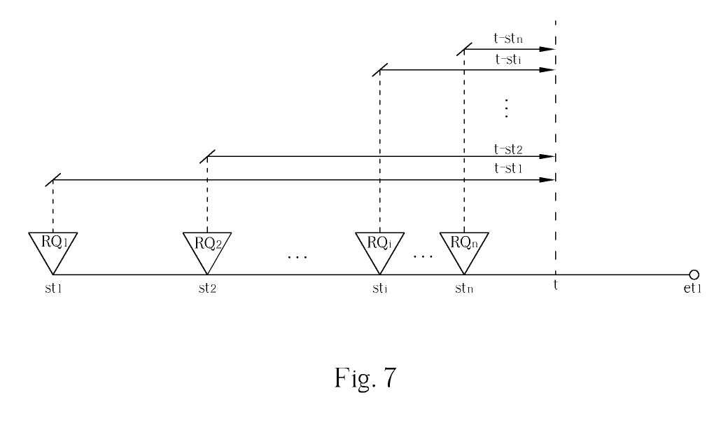

In step 408 and step 410, the method of calculating the waiting time of each request, the request number, and the accumulated waiting time, i.e., calculating the weighted value WSIN(t), is further described in FIG. 5, FIG. 6, and FIG. 7. In step 414, when the end time of the data item has been passed, the data item is no longer necessary to be broadcasted, therefore, another data item to be broadcasted at the next time is scheduled immediately. The values of the current adjustable parameters α, β, and γ in step 418 are not less than zero. When the values of the current adjustable parameters β and γ equal zero, the method of scheduling the sequence of broadcasting data items of the present invention is a most requests first algorithm. When the values of the current adjustable parameters α and γ equal zero, the method of scheduling the sequence of broadcasting data items of the present invention is an earliest deadline first algorithm.

Please refer to FIG. 5, which is a diagram of describing the formula of scheduling the sequence of broadcasting data items of the present invention. As shown in FIG. 5, there are four requests RQ₁, RQ₂, RQ₃, and RQ₄ on the time axis. The issued order of the requests on the time axis is RQ₁, RQ₂, RQ₃, and RQ₄, and the first issued request is the request RQ₁. st is a start time, et is an end time, and dt is a pending duration, which is the time difference between the start time st and the end time et, and can be denoted as: dt=et−st.

Please refer to FIG. 6, which is a diagram illustrating the formula issued in FIG. 5 for scheduling the request RQ₁ of the present invention. As shown in FIG. 6, on the time axis, a first start time st₁ denotes the time when the request RQ₁ is issued, t denotes a current time, et1 denotes a first end time of the request RQ₁, and a first pending duration dt₁ denotes the time difference between the first start time st₁ and the first end time et₁, and can be denoted as: dt₁=et₁−st₁. The time difference between the current time t and the first start time st₁ is (t−st₁). The time difference between the first end time et₁ and the current time t is [dt₁−(t−st₁)].

Similarly, n formulae relating to n requests can thus be generated, and n is a positive integer. Please refer to FIG. 7, which is a diagram illustrating n formulae for scheduling n requests. As shown in FIG. 7, there are n requests RQ₁, RQ₂, . . . , RQₙ on the time axis. The issued order of the requests is RQ₁, RQ₂, . . . , RQₙ. st₁ denotes a first start time when the request RQ₁ is issued, t denotes a current time, et₁ denotes a first end time of the request RQ₁, and dt₁ denotes a pending duration, which is the time difference between the first start time st₁ and the first end time et₁. The pending duration dt₁ may also be denoted as: dt₁=et₁−st₁. Similarly, st₂ denotes a second start time of the request RQ₂, and stₙ denotes an n-th start time of the request RQₙ; et₂ denotes a second end time of the request RQ₂, and etₙ denotes an n-th end time; the second pending duration dt₂ may be denoted as: dt₂=et₂−st₂, and the pending duration dtₙ may also be denoted as: dtₙ=etₙ−stₙ.

Please refer to FIG. 7 again. The method of the present invention is described mathematically as follows. In the step 408 of FIG. 4, an accumulated waiting time W(t) of each request is calculated as follows: W(t)=Σᵢ₌₁^{i≦n}(t−stᵢ); n denotes the request number, t denotes the current time, and stᵢ denotes a start time of request RQᵢ of the data item. In the step 410 of FIG. 4, the weighted value WSIN(t) of the data item is calculated as follows:

WSIN(t)=n^{α}*(Σᵢ₌₁^{i≦n}(t−stᵢ)/dt)^{γ}; Formula 1:

WSIN(t)=n^{α}*(1/et−t)^{β}*(Σᵢ₌₁^{i≦n}(t−stᵢ)/dt)^{γ}; Formula 2:

α, β, γ denote adjustable parameters, n denotes the request number, t denotes the current time, stᵢ denotes the i-th start time of the request RQᵢ, and et denotes the end time. The values of the adjustable parameters α, β, γ are not less than zero. When the values of the adjustable parameters β and γ equal zero, the method of scheduling the sequence of broadcasting data items of the present invention is a most requests first algorithm. When the values of the adjustable parameters α and γ equal zero, the method of scheduling the sequence of broadcasting data items of the present invention is an earliest deadline first algorithm.

The abovementioned formulae are merely utilized for describing the method of the present invention. The method of the present invention is not limited to the abovementioned formulae either. The abovementioned adjustable parameters α, β, γ are not constants. Under various conditions or various requirements, the adjustable variables α, β, γ may be adjusted for meeting the various conditions or the various requirements. The method of the present invention is not limited to variations of the adjustable parameters α, β, and γ either.

The present invention provides a method of scheduling a sequence of broadcasting data items in an on-demand broadcast system. A weighted value is calculated according to a request number and an accumulated waiting time. The sequence of broadcasting the plurality of data items is also determined according to the weighted value. The method of the present invention does not merely meet the urgency of the issued requests, but achieves higher productivity also. The method of the present invention also takes the mean access time into consideration, thereby, obviously enhancing the efficiency of the on-demand broadcast system having a great plurality of service terminals. Moreover, through appropriately determining the values of the adjustable parameters α, β, γ, the method of the present invention is compatible with the earliest deadline first algorithm, the most requests first algorithm, and the sin-α algorithm of prior art.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for scheduling sequence of broadcasting data items in an on-demand broadcast system, the on-demand broadcast system comprising a plurality of data items; the method comprising:
receiving a plurality of requests, each of the plurality of requests requesting to broadcast a data item;
calculating a request number of the plurality of requests wherein the request number represents the number of the plurality of requests;
calculating a waiting time of each of the plurality of requests, each of the waiting times corresponding to a current time, and summing each of the waiting times as an accumulated waiting time;
calculating a weighted value according to the request number and the accumulated waiting time; and
scheduling the order of broadcasting the plurality of data items according to the calculated weighted values of the plurality of data items.

2. The method of claim 1 wherein the accumulated waiting time is denoted and calculated as follows:
W(t)=Σᵢ₌₁^{i≦n}(t−stᵢ)
wherein W(t) denotes the accumulated waiting time, n denotes the request number, t denotes the current time, and stᵢ denotes a starting time corresponding to the data item.

3. The method of claim 2 further comprising:
broadcasting the data item before an end time of the data item.

4. The method of claim 2 wherein the weighted value is denoted and calculated as follows:
WSIN(t)=n_{α}*(Σᵢ₌₁^{i≦n}(t−stᵢ)/dt)^{γ}
wherein WSIN(t) denotes the weighted value, α and γ denote adjustable parameters, n denotes the request number, t denotes the current time, stᵢ denotes the starting time corresponding to the data item, and dt denotes a pending duration, which is a time difference between an end time for broadcasting the data item and the time when the data item is requested to be broadcasted at the first time.

5. The method of claim 2 wherein the weighted value is denoted and calculated as follows:
WSIN(t)=n^{α}*(1/et−t)^{β}*(Σᵢ₌₁^{i≦n}(t−stᵢ)/dt)^{γ}
wherein WSIN(t) denotes the weighted value, α, β, and γ denote adjustable parameters, n denotes the request number, t denotes the current time, stᵢ denotes the starting time corresponding to the data item, et denotes the end time, and dt denotes a pending duration, which is a time difference between the end time for broadcasting the data item and the time when the data item is requested to be broadcasted at the first time.

6. The method of claim 5 wherein the values of the adjustable parameters α, β, and γ are not less than zero.

7. The method of claim 5 wherein when the values of the adjustable parameters β and γ are zero, the method is a most requests first (MRF) algorithm.

8. The method of claim 5 wherein when the values of the adjustable parameters α and γ are zero, the method is an earliest deadline first (EDF) algorithm.

9. The method of claim 5 further comprising:
determining whether to adopt current adjustable parameters α, β, and γ; and
inputting the current adjustable parameters α, β, and γ.

10. The method of claim 1 further comprising:
comparing the weighted values corresponding to the plurality of data items at the current time; and
selecting a data item corresponding to a highest weighted value to broadcast.

11. A system for scheduling sequence of broadcasting data items, the system utilized for communicating with a plurality of service terminals; the system comprising:
a database utilized for storing a plurality of data items;
a service queue;
a receiving unit utilized for receiving a plurality of requests from the plurality of service terminals, the plurality of requests corresponding to a data item in the database;
a scheduler utilized for calculating a weighted value and scheduling the order of putting the data item into the service queue, the weighted value corresponding to a request number of the plurality of requests and to a sum of waiting times of the plurality of requests, and the waiting times of the plurality of requests corresponding to a current time; and
a transmission unit coupled to the service queue and utilized for downloading the data item to the plurality of service terminals.

12. The system of claim 11 wherein the sum of waiting times of the plurality of requests is an accumulated waiting time, which is denoted and calculated as follows:
W(t)=Σᵢ₌₁^{i≦n}(t−stᵢ)
wherein W(t) denotes the accumulated wait time, n denotes the request number, t denotes the current time, and stᵢ denotes the start time of a request corresponding to the data item.

13. The system of claim 11 wherein the weighted value is denoted and calculated as follows:
WSIN(t)=n^{α}*(Σᵢ₌₁^{i≦n}(t−stᵢ)/dt)^{γ}
wherein WSIN(t) denotes the weighted value, α and γ denote adjustable parameters, n denotes the request number, t denotes the current time, stᵢ denotes the start time of a request corresponding to the data item, and dt denotes a pending duration, which is a time difference between the end time for broadcasting the data item and the time when the data item is requested to be broadcasted at the first time.

14. The system of claim 111 wherein the weighted value is denoted and calculated as follows:
WSIN(t)=n^{α}*(1/et−t)^{β}*(Σᵢ₌₁^{i≦n}(t−stᵢ)/dt)^{γ}
wherein WSIN(t) denotes the weighted value, α, β, and γ denote adjustable parameters, n denotes the request number, t denotes the current time, stᵢ denotes the starting time of a request corresponding to the data item, et denotes the end time, and dt denotes a pending duration, which is a time difference between the end time for broadcasting the data item and the time when the data item is requested to be broadcasted at the first time.

15. The system of claim 14 wherein the values of the adjustable parameters α, β, and γ are not less than zero.
